(19) United States
(12) Patent Application Publication
(10) Pub. No.: US 2023/0286203 A1
(43) Pub. Date: Sep. 14, 2023

(54) METHOD FOR PRODUCING A PREFORM

(71) Applicant: ALPLA WERKE ALWIN LEHNER GMBH & CO. KG, Hard (AT)

(72) Inventor: Gustavo Expósito Roda, Requena (ES)

(21) Appl. No.: 18/040,804

(22) PCT Filed: Aug. 4, 2021
(86) PCT No.: PCT/EP2021/071771

§ 371 Date: Feb. 6, 2023

(30) Foreign Application Priority Data
Aug. 5, 2020 (EP) 20382726.6

(51) Int. Cl. B29C 49/64; B29C 49/06; B29B 11/14; B29C 45/72; B29C 49/00

(52) U.S. Cl. CPC B29C 49/6435; B29C 49/06; B29B 11/14; B29C 45/7207; B29C 49/071; B29K 2105/258

(57) ABSTRACT

A method for producing a preform includes inserting the preform, while still hot after having been injection molded, into a cooling apparatus, which cooling apparatus has an internal space, the inner contours of which conform to the outer contours of the preform. A negative pressure is generated between the inner contours of the internal space (29) and the outer contours of the preform. The injection point created on the preform during injection molding is pushed by the negative pressure to a stamp present on the inner contour and pressed to the stamp.

### CROSS-REFERENCE TO RELATED APPLICATIONS

This application is a national phase entry under 37 U.S.C. § 371 of PCT/EP2021/071771 filed Aug. 4, 2021, which claims priority to European Patent Application No. 20382726.6 filed Aug. 5, 2020, the entirety of each of which is incorporated by this reference.

### FIELD OF THE INVENTION

The invention relates to a method for producing a preform, while still hot after having been injection molded, that is inserted into a cooling apparatus for cooling the preform, and a plastic container produced from the preform by a stretch blowing method.

### PRIOR ART

Preforms which are intended to be shaped in a stretch blowing method to form bottles usually have an injection point. The injection point arises during the formation of the preform in the injection mold at the injection point since the inlet of the molten plastic material injected must be separated from the remaining melt in the hot runner. This is frequently achieved by means of a needle valve, but there are also other forms of separation.

The existing injection point is undesirable for many reasons: For example, what is known as “angel hair” can be formed at the injection point, which can contaminate the blow mold. Furthermore, the injection point can negatively influence the stress crack and fracture strength of the bottle and lead to uneven material distributions during the stretch blowing. Likewise, the injection point is visually unattractive and is therefore also undesirable for marketing reasons.

For subsequent removal of the injection point, methods, such as cutting, burning or brushing of the excess material, are known. The preform can also be compression molded instead of injection molded. However, these types of removal are time-consuming and cost-intensive.

### Advantages of the Invention

From the disadvantages of the prior art described, a preform is produced by injection molding, which has no or a very small injection point.

Further, no material fibers or sharp edges are present on the injection-molded preform, which can detach or break off from the preform and thereby contaminate the blow mold or the blown bottle, which can lead, for example, to undesired images or imprints on the blown bottle.

### SUMMARY OF THE INVENTION

The stated advantages are achieved, in the case of a method for producing a preform, by the features listed herein. Developments and/or advantageous alternative embodiments are also set forth herein.

The invention provides that the injection point formed on the preform during injection molding is pushed by the negative pressure onto a stamp, which is present on the inner contour, and is pressed on the stamp. As a result, the necessary machining of the injection point is not carried out in an additional working step using an additional machine, but during the cooling process, which is necessary anyway. In addition, the injection point has the highest temperature of the preform before the preform is introduced into the cooling apparatus. As a result, the injection point can be deformed particularly easily or even eliminated by a stamp in the cooling apparatus.

Advantageously, after the pressing, the injection point has a length and height of less than 1 mm. The smaller the injection point or its dimensions after pressing, the better all the disadvantages for which the injection point is responsible are avoided.

It has proven expedient if the negative pressure is less than 0.9 bar absolute pressure. The negative pressure for the cooling can therefore be maintained unchanged for the pressing of the injection point.

A further aspect of the invention relates to an apparatus for cooling a preform according to the above method. The apparatus comprises a stamp that is formed on the inner contour of the internal space, on which stamp the injection point of a preform can be positioned. The vacuum therefore not only serves to cool the preform, but rather the force caused thereby presses the injection point relative to the rest of the preform, and therefore two process steps can be implemented at the same time in the apparatus.

The stamp is expediently arranged on the base since the injection point is usually formed on the preform base.

In one embodiment of the invention, the second opening is provided on the base and the stamp is arranged in the second opening. As a result, the stamp can be easily integrated into the existing housing of a cooling apparatus.

In another embodiment, the stamp is the head of a screw, which screw serves to fasten the base. Therefore, no additional stamping device is required, and the fastening screw takes over the stamping function in a surprisingly simple manner.

In another embodiment of the invention, the screw head is in the shape of an external hexagonal head. In comparison with a hexagon socket screw head, this has a sufficiently large surface on which the injection point can be pressed. Other screw heads are also conceivable, provided they have a sufficiently large pressing surface for pressing the injection point.

Due to the fact that the internal diameter of the second opening is larger than the largest external diameter of the stamp, there is space around the stamp in order to be able to suction sufficient air between the internal space and the preform body.

In another embodiment of the invention, the screw is arranged in the second opening in such a way that the upper side of the screw head is flush with the base. As a result, the injection point can be pressed in such a way that the preform base is as flat as possible. It is conceivable that the screw head projects into the internal space of the housing. As a result, the contact pressure on the injection point or the preform base can be increased.

In another embodiment of the invention, the height of the screw head is dimensioned such that the position of the upper side of the screw head relative to the base is determined thereby. As a result, the stamp surface can be positioned at the desired height in a simple manner by dimensioning the height of the screw head.

A further aspect of the invention relates to a preform which has been processed in the above-described cooling apparatus. The preform may be configured such that the injection point formed on the base during the cooling process is deformed or pressed during the injection molding such that it has a length and height of less than 1 mm and is free of protruding material fibers. These material fibers can be, for example, angel hairs and edges which detach in the blow mold and contaminate the surface thereof during the molding of the bottle or form an image of the soiling on the blown bottle. In the present preform, such material fibers are reliably pressed with the preform base. In addition, the dimensions of the injection point are minimized by the pressing thereof. The present preform therefore does not have any of the disadvantages related to the injection point. In addition, the reduction in size or the elimination of the injection point takes place without further expenditure of time or material during the preform production or the cooling of the preform.

Another aspect of the invention relates to a plastic container produced in a stretch blowing method from a preform described further above. By pressing the injection point during the cooling of the preform, the container remains virtually free of stresses in the region of the injection point after it has been stretch blown.

### BRIEF DESCRIPTIONS OF THE DRAWINGS

Further advantages and features will become apparent from the following description of an embodiment of the invention with reference to the schematic drawings, in which, in a representation not true to scale:

FIG. 1: is a side view of a preform comprising an injection point;

FIG. 2: is a sectional view of the preform inserted into a cooling apparatus (robot tube);

FIG. 3: is an enlarged view of the preform base;

FIG. 4: is a sectional view of the preform inserted into a cooling apparatus according to the invention;

FIG. 5: is an enlarged view of the preform base after pressing of the injection point;

FIG. 6: is a view of the screw for fixing the base of the robot tube; and

FIG. 7: is a plan view of the base of the robot tube comprising an inserted screw.

### DETAILED DESCRIPTION OF THE INVENTION

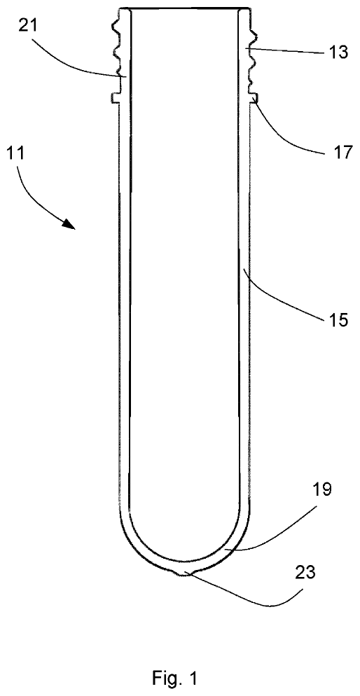

FIG. 1 shows a typical preform 11 comprising a preform neck 13 and a preform body 15 adjoining the preform neck 13. A support ring 17 is usually formed at the transition from the neck 13 to the body 15. The body 15 has a preform base 19 at its lower end. An external thread 21 can be formed on the neck 13. Since the preform 11 is produced in an injection molding method, it inevitably has an injection point 23. The injection point 23 results from the melt inlet into the injection mold, which can be closed by a needle. The preform 11 can be injection-molded from a plurality of plastic melts, for example, PET, PP, HDPE, PEF, PA, PEN, and/or PLA. The most widely used plastics are PET and rPET. In particular, in the case of preforms for multi-way applications, typical polyester materials, such as Akestra, but also Tritan or the like, are used.

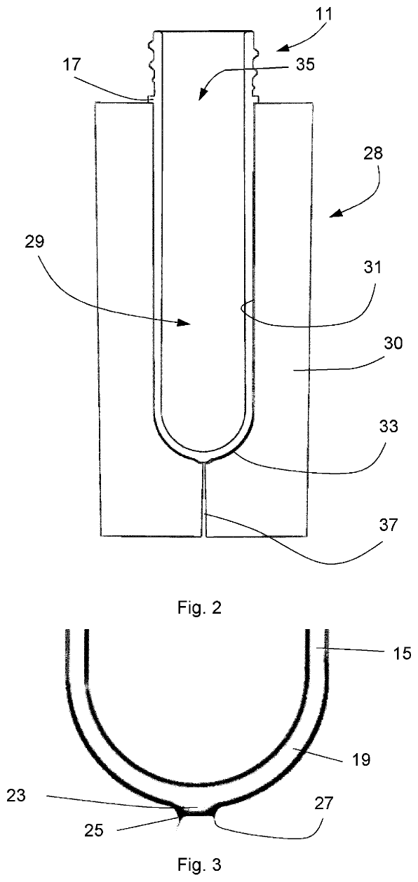

FIG. 2 shows a conventional cooling apparatus in which the injection point 23 of the preform 11 remains unchanged.

FIG. 3 shows the forms that the injection point 23 can assume. Among other things, sharp edges 25, or what is known as angel hair 27, are possible. Such formations are undesirable since they can lead to contamination on the stretch-blown bottle. During stretch blowing, the injection point can also lead to irregular material distributions because the injection point is pushed from the center to the side during stretching. This deformation of the injection point during stretching can lead to stresses in the bottle, which cause stress cracks or fractures immediately or later during storage. These stresses can overlap, in particular in the case of bottles that are subjected to an internal pressure.

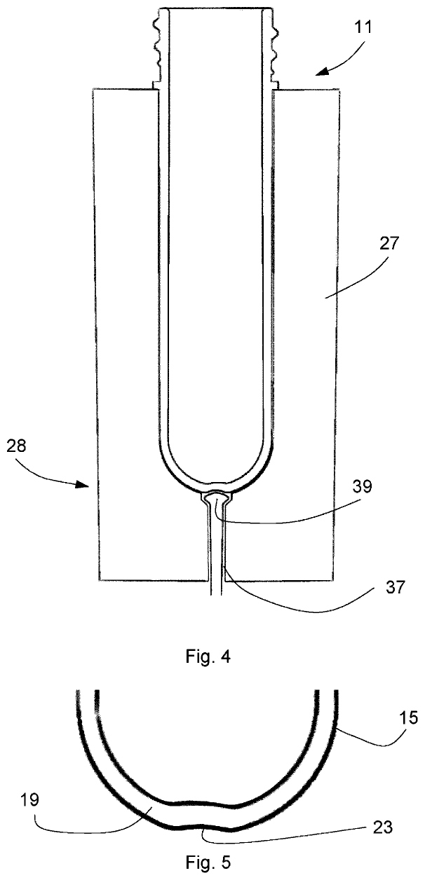

FIG. 4 shows the preform 11 received in a cooling apparatus 28 according to the invention. Such a cooling apparatus is also referred to as a “robot tube.” The cooling apparatus 28 comprises a housing 30 that borders an internal space 29. The internal space 29 is delimited by side walls 31 and a base 33. A first opening 35 is provided on the upper side of the housing 30, through which opening the preform 11, still hot after injection molding, can be inserted into the internal space 29. The support ring 17 can rest on the upper end of the housing 27. The inner dimensions of the internal space 29 are identical to the outer dimensions of the preform body 15. The internal space 29 is therefore a negative impression of the preform body 15.

On the opposite lower side, a second opening 37 is provided on the base 33, through which opening air is suctioned off in order to build up a negative pressure between the preform body 15 and the side walls 31 and the base 33. This accelerates the cooling of the preform 11, as a result of which the material properties of the preform 11 are improved.

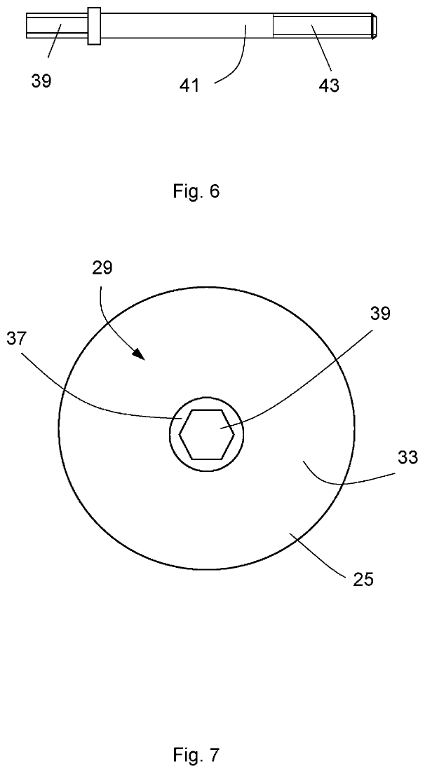

In one embodiment of the invention, a stamp in the form of a screw head 39 is arranged in the second opening 37. FIG. 6 shows the screw head 39 part of a screw 41, which serves to fasten the base 33 or the apparatus 25. Of course, the screw 41 comprises a screw thread 43. The internal diameter of the second opening 37 is expediently greater than the largest external diameter of the screw head 39, in order that sufficient air can be suctioned through the second opening 37 (FIG. 7).

When the vacuum is built up, which corresponds to an absolute pressure of less than 0.9 bar, the injection point 23 is pressed onto the screw head 39. Due to the fact that the injection point 23 is one of the hottest parts of the preform 11, it can be compressed particularly efficiently. In this case, edges and “angel hair” disappear, and the dimensions of the injection point 23 are reduced. As a result, all the above-mentioned negative properties of the injection point 23 are no longer present.

The upper side of the screw head 39 should be flush with the base 33. As a result, a surface, which is as smooth as possible, can be achieved on the preform base 19 in the region of the injection point. The flush nature of the surface can be achieved by adapting the length of the screw head 39.

It is also conceivable that the stamp 39 projects beyond the base 33, as is shown in FIG. 4. The preform base 19 can then be pressed inwards (See FIG. 5), and even more pressure can be exerted on the injection point 23.

1. A method for producing a preform, comprising:
inserting a preform that has been formed by injection molding, and that is still hot after having the injection molding, into a cooling apparatus, the cooling apparatus comprising inner contours defining an internal space, the inner contours matching the outer contours of the preform;
generating a negative pressure between the inner contours of the cooling apparatus and the outer contours of the preform; and
pressing an injection point created on the preform during the injection molding of the preform against a stamp positioned proximate the injection point by the negative pressure generated between the inner contours and outer contours.

2. The method according to claim 1, wherein the injection point has a length and height of less than 1 mm after pressing.

3. The method according to either claim 1, wherein the negative pressure is less than 0.9 bar absolute pressure.

4. A cooling apparatus for cooling a preform that has been formed by injection molding, and that is still hot after the injection molding, the cooling apparatus comprising:
a housing having side walls and a base that define an internal space;
a first opening through which a preform can be inserted into the internal space;
a second opening through which air can be extracted; and
a stamp configured for pressing against an injection point of the preform, the stamp at least partially positioned in the the internal space of the cooling apparatus.

5. The cooling apparatus according to claim 4, wherein the stamp is arranged proximate the base.

6. The cooling apparatus according to claim 4, wherein the base defines the second opening and the stamp is at least partially positioned within the second opening.

7. The cooling apparatus according to claim 4, wherein the stamp comprises a screw head of a screw, and the screw is configured to fasten to the base.

8. The cooling apparatus according to claim 7, wherein the screw head is in comprises an external hexagonal head.

9. The cooling apparatus according to claim 4, wherein an internal diameter of the second opening is greater than a largest external diameter of the stamp.

10. The cooling apparatus according to claim 7, wherein the screw is at least partially positioned within the second opening such that an upper side of the screw head is substantially flush with the base.

11. The cooling apparatus according to any of claims 7 to 10, characterized in that the height of the screw head is dimensioned such that the position of the upper side of the screw head relative to the base is determined thereby.

12. A preform produced by an injection molding process, comprising:
a preform neck;
a preform body having a preform base, the preform body adjoining the preform neck; and
a deformed or pressed injection point on the preform body that has been deformed or pressed on the preform base during the injection molding process of forming the preform such that the injection point has a length and height of less than 1 mm and is free from protruding material fibers.

13. The preform according to claim 12, wherein the preform base is inwardly curved in a region of the injection point.

14. A container produced from an injection molded preform and formed by stretch blowing, the injection molded preform having a preform neck, a preform body adjoining the preform neck, and a deformed or pressed injection point on the preform body that has been deformed or pressed on a preform base of the preform body during the injection molding processes, such that the injection point has a length and height of less than 1 mm and is free from protruding material fibers.

15. The container of claim 14, wherein the container is virtually free of stresses in the region of the injection point after it has been stretch blown.
